(19) United States
(12) Patent Application Publication
(10) Pub. No.: US 2021/0134505 A1
(43) Pub. Date: May 6, 2021

(54) THIN-FILM INDUCTOR AND METHOD FOR MANUFACTURING THE SAME

(71) Applicant: Ralec Electronic Corporation, Kaohsiung (TW)

(72) Inventors: Tim Wang, Kaohsiung (TW); Peter Chen, Kaohsiung (TW)

(21) Appl. No.: 16/853,487

(22) Filed: Apr. 20, 2020

(30) Foreign Application Priority Data
Oct. 30, 2019 (TW) 108139293

(51) Int. Cl. H01F 17/00

(52) U.S. Cl. CPC H01F 17/0033; H01F 17/0013

(57) ABSTRACT

A thin-film inductor includes an electrically conductive structure, an inductance-enhancing structure and two terminal electrodes. The electrically conductive structure has a coil pattern, and includes an insulating base plate having via extending therethrough, upper and lower coils formed on two opposite surfaces of the insulating base plate, and a conducting member disposed in and fills the via to electrically connect the upper and lower coils. The inductance-enhancing structure covers the electrically conductive structure and fills a space defined by the electrically conductive structure to expose an electrode contact region of the lower coil. The terminal electrodes are disposed on the electrode contact region.

### CROSS-REFERENCE TO RELATED APPLICATION

This application claims priority of Taiwanese Invention Patent Application No. 108139293, filed on Oct. 30, 2019.

### FIELD

This disclosure relates to a thin-film inductor, and more particularly to a thin-film inductor having terminal electrodes installed on a same side.

### BACKGROUND

With the advancement of semiconductor technology, it has become a trend to develop lightweight and thin electronic devices. To meet such requirements, various passive components installed in the electronic devices (e.g., resistors, capacitors, or inductors) need to be miniaturized.

For example, a mini molding choke is a type of integrally-formed inductor which is generally made by first coiling a wire to form a coil circuit, then packaging the coil circuit to obtain a packaged semi-product, and finally forming two terminal electrodes on two opposite sides of the packaged semi-product to obtain a final product. However, formation of the terminal electrodes on two opposite sides of the mini molding choke may cause difficulty in miniaturization of the mini molding choke. In addition, when the mini molding choke is soldered to an external circuit board through the terminal electrodes, soldering agent might easily reflow around the terminal electrodes, resulting in reduced space of the external circuit board for soldering other components thereon.

### SUMMARY

Therefore, an object of the disclosure is to provide a thin-film inductor that can alleviate or eliminate at least one of the drawbacks of the prior art.

According to the disclosure, the thin-film inductor includes an electrically conductive structure, an inductance-enhancing structure, and two terminal electrodes. The electrically conductive structure has a coil pattern, and includes an insulating base plate, an upper coil, a lower coil, and a conducting member. The insulating base plate has an upper surface, a lower surface opposite to the upper surface, and a via extending from the upper surface to the lower surface. The upper coil is formed on the upper surface of the insulating base plate, and the lower coil formed on the lower surface of the insulating base plate. The conducting member is disposed in and fills the via of the insulating base plate to electrically connect the upper coil and the lower coil. The inductance-enhancing structure covers the electrically conductive structure and fills a space defined by the electrically conductive structure such that an electrode contact region of a surface of the lower coil opposite to the insulating base plate is exposed. The two terminal electrodes are disposed on the electrode contact region of the lower coil.

### BRIEF DESCRIPTION OF THE DRAWINGS

Other features and advantages of the disclosure will become apparent in the following detailed description of the embodiment with reference to the accompanying drawings, in which:

FIG. 1 is a perspective view of an embodiment of a thin-film inductor according to the disclosure;

FIG. 2 is a schematic cross-sectional view of the embodiment of the thin-film inductor taken along line II-II of FIG. 1;

FIG. 3 is a flow chart illustrating a method for manufacturing the embodiment of the thin-film inductor according to the disclosure; and

FIGS. 4 to 7 are fragmentary schematic cross-sectional views illustrating consecutive steps for manufacturing the embodiment of the thin-film inductor according to the disclosure.

### DETAILED DESCRIPTION

Before the disclosure is described in greater detail, it should be noted that where considered appropriate, reference numerals have been repeated among the figures to indicate corresponding or analogous elements, which may optionally have similar characteristics.

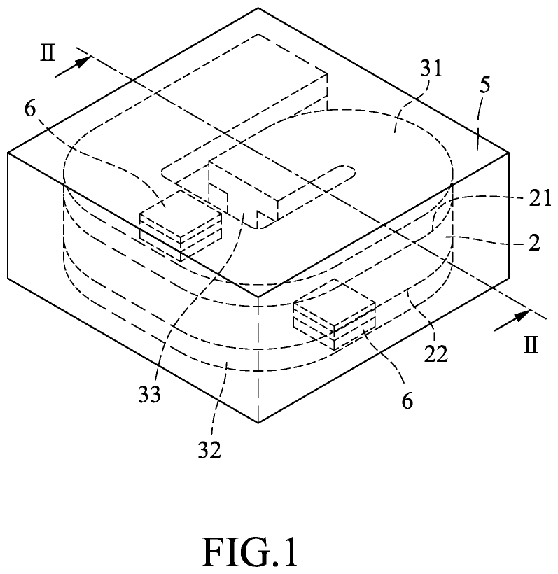

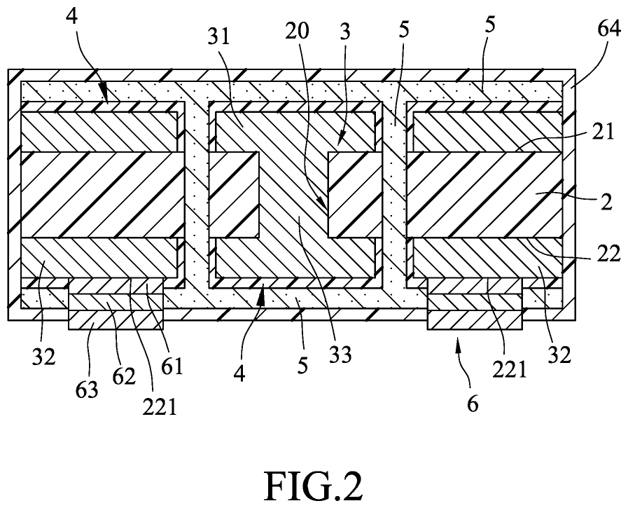

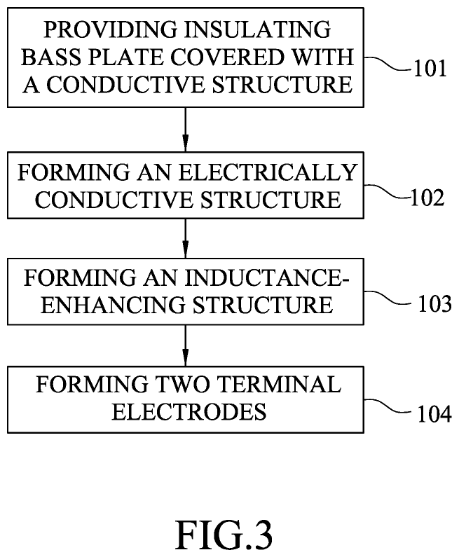

Referring to FIGS. 1 and 2, an embodiment of a thin-film inductor according to the disclosure includes an electrically conductive structure 3, an insulating unit 4, an inductance-enhancing structure 5, two terminal electrodes 6, and an insulating wrap 64.

The electrically conductive structure 3 has a coil pattern, and includes an insulating base plate 2, an upper coil 31, a lower coil 32, and a conducting member 33.

The insulating base plate 2 has an upper surface 21, a lower surface 22 opposite to the upper surface 21 and a via 20 extending from the upper surface 21 to the lower surface 22. The insulating base plate 2 may be made of polyimide, but is not limited thereto. The upper coil 31 is formed on the upper surface 21 of the insulating base plate 2. The lower coil 32 is formed on the lower surface 22 of the insulating base plate 2, and has an electrode contact region 221 formed on a surface opposite to the insulating base plate 2. The conducting member 33 is disposed in and fills the via 20 of the insulating base plate 2 to electrically connect the upper coil 31 and the lower coil 32. The upper and lower coils 31, 32 may have a multi-layered structure, and the configuration, thickness and number of layers thereof may be selected and optimized by those skilled in the art according to practical requirements. In this embodiment, the upper and lower coils 31, 32 and the conducting member 33 are made of copper, and each of the upper and lower coils 31, 32 has a spiral shape, but, are not, limited thereto.

The insulating unit 4 includes an upper insulating layer 41 disposed over the upper coil 31 and a lower insulating layer 42 disposed over the lower coil 32. In this embodiment, the insulating unit 4 is made of insulating ink, but is not limited thereto.

The inductance-enhancing structure 5, which may be made of a magnetic material, covers the electrically conductive structure 3 and the insulating unit 4, and fills a space defined by the electrically conductive structure 3 such that the electrode contact region 221 of the lower coil 32 is exposed.

The two terminal electrodes 6 are disposed on the electrode contact region 221 of the lower coil 32. In this embodiment, each of the two terminal electrodes 6 includes a copper layer 61 formed on the electrode contact region 221 of the lower coil 32, a nickel layer 62 formed on the copper layer 61, and a tin layer 63 formed on the nickel layer 62.

The insulating wrap 64 encloses the electrically conductive structure 3, the insulating unit 4, and the inductance-enhancing structure 5 such that the terminal electrodes 6 are exposed.

Referring to FIG. a method for manufacturing the embodiment of the thin-film inductor of the disclosure includes the following steps 101 to 104.

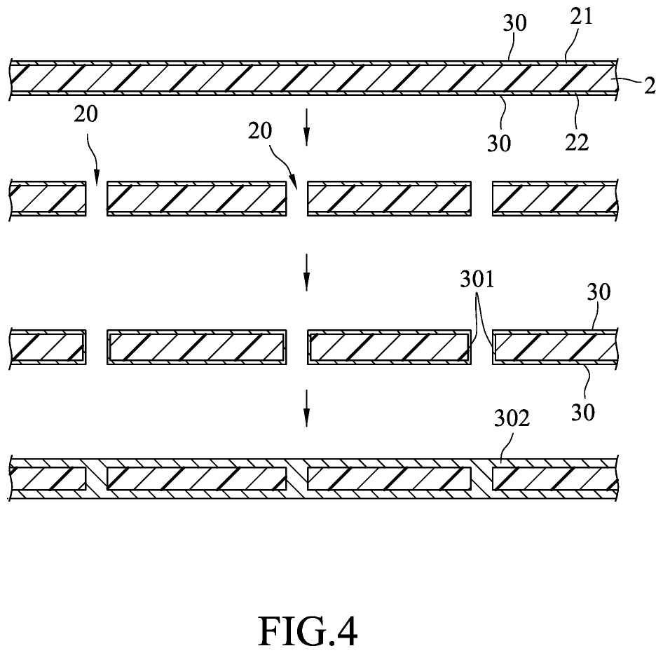

Referring to FIG. 4, in step 101, the insulating base plate 2 is provided, and a copper seed layer 30 is formed on each of the upper and lower surfaces 21, 22 of the insulating base plate 2. That is, the insulating base plate 2 is sandwiched between the copper seed layers 30. Then, the copper seed layers 30 and the insulating base plate 2 are cut by laser to form a plurality of the vias 20 extending therethrough, followed by forming a copper film 301 along the vias 20 by a sputtering process to cover side surfaces of the insulating base plate 2. Thereafter, a copper layer 61 having a thickness greater than those of the copper seed layer 30 and the copper film 301 is formed on the copper seed layers 30 and the copper films 301 by an electroplating process to fill in the vias 20. The copper layer 61, the copper seed layers 30 and the copper film 301 cooperatively form a conductive structure 302.

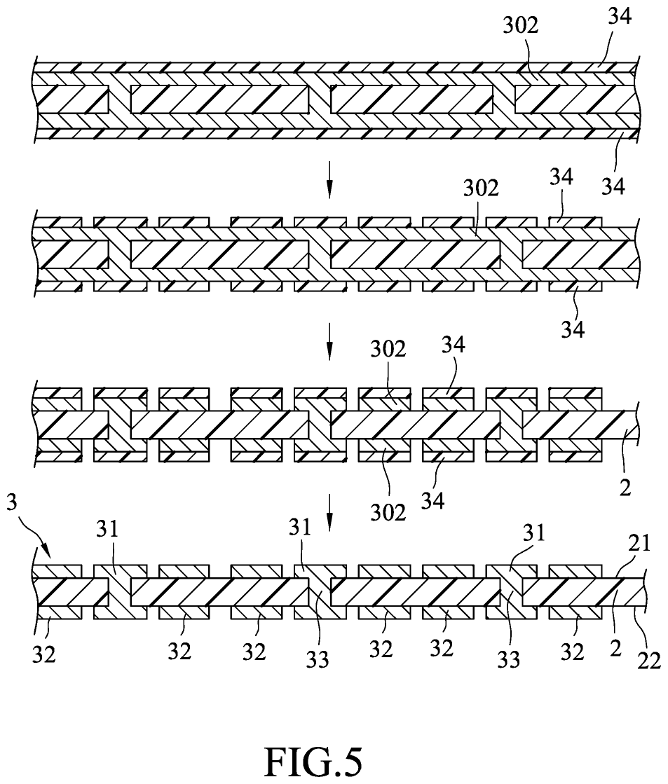

Referring to FIG. 5, in step 102, each of two opposite surfaces of the conductive structure 302 is covered with a mask layer 34, which is then subjected to a photolithography process expose predetermined regions (different from regions corresponding in position to the vias 20) of the conductive structure 302 that form a coil pattern having a spiral shape. Next, the predetermined regions of the conductive structure 302 are etched to expose the base plate 2, and then the mask layers 31 are removed so as to obtain the electrically conductive structure 3 having the coil pattern, and including the upper coil 31 disposed on the upper surface 21 of the insulating base plate 2, the lower coil 32 disposed on the lower surface 22 of the insulating base plate 2, and the conducting member 33 filling the vias 20 to connect the upper and lower coils 31, 32. The lower coil 32 has the electrode contact region 221 opposite to the insulating base plate 2.

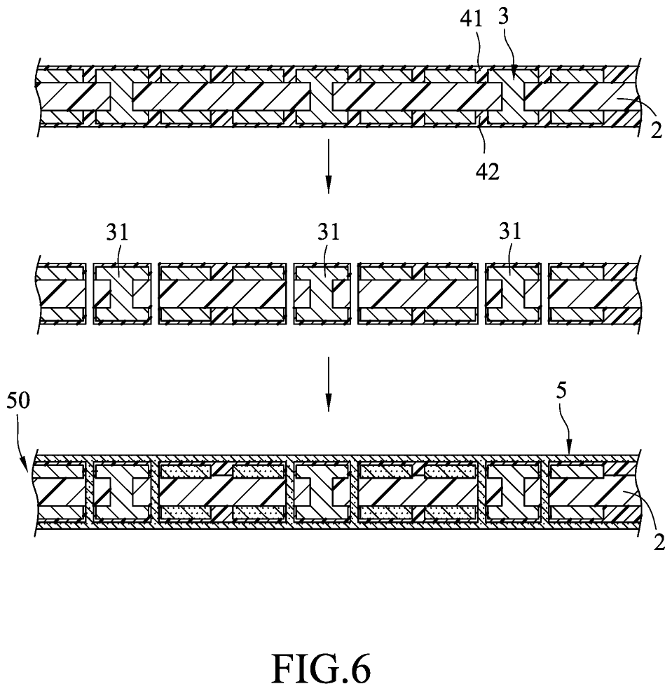

Referring to FIG. 6, in step 103, the upper coil 31 and the lower coil 32 are printed with insulating ink to respectively form the upper insulating layer 41 disposed over the upper coil 31 and the lower insulating layer 42 disposed over the lower coil 32. The upper insulating layer 41 and the lower insulating layer 42 cooperatively define the insulating unit 4. Then, the insulating unit 4 and the insulating base plate 2 are removed by a laser cutting process such that the insulating unit 4 and the insulating base plate 2 have a pattern corresponding in shape to the coil pattern of the electrically conductive structure 3. Thereafter, a magnetic material is applied on the electrically conductive structure 3 and the insulating unit 4, followed by subjecting the conductive structure 3, the insulating unit 4 and the magnetic material to a molding process so as to form the inductance-enhancing structure 5 that encloses the electrically conductive structure 3 and the insulating unit 4, thereby obtaining an inductor body 50.

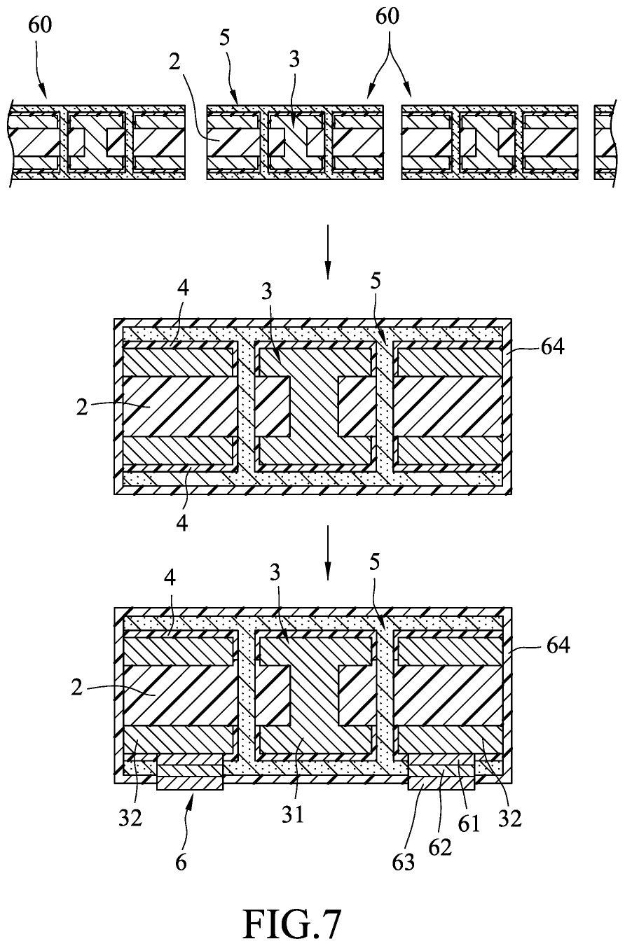

Referring to FIG. 7, in step 104, the inductor body 50 is diced into a plurality of semi-products 60, each of which is then enclosed by the insulating wrap 64. Next, in each of the semi-products 60, a portion of the insulating wrap 64 is removed to expose the electrode contact region 221 of the lower coil 32. Subsequently, the copper layer 61, the nickel layer 62, and the tin layer 63 are sequentially formed on the electrode contact region 221 to form the terminal electrodes 6, thereby obtaining the embodiment of the thin-film inductor according to the disclosure.

In sum, with the conducting member 33 filling in the via 20 to electrically connect the upper coil 31 to the lower coil 32, the two terminal electrodes 6 can be formed on the lower coil 32, which enables miniaturization of the thin-film inductor of this disclosure. In addition, since the inductance-enhancing structure 5 is made of a magnetic material, inductance of the thin-film inductor of this disclosure can be improved.

In the description above, for the purposes of explanation, numerous specific details have been set forth in order to provide a thorough understanding of the embodiment. It will be apparent, however, to one skilled in the art, that one or more other embodiments may be practiced without some of these specific details It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what s considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A thin-film inductor, comprising:
an electrically conductive structure having a coil pattern and including
an insulating base plate that has an upper surface, a lower surface opposite to said upper surface, and a via extending from said upper surface to said lower surface,
an upper coil formed on said upper surface of said insulating base plate,
a lower coil formed on said lower surface of said insulating base plate, and having: an electrode contact region opposite to said insulating base plate, and
a conducting member disposed in and fills said via of said insulating base plate to electrically connect said upper coil and said lower coil;
an inductance-enhancing structure covering said electrically conductive structure and filling a space defined by said electrically conductive structure such that said electrode contact region of said lower coil is exposed; and
two terminal electrodes disposed on said electrode contact region of said lower coil.

2. The thin-film inductor according to claim 1, wherein said upper coil has a spiral shape.

3. The thin-film inductor according to claim 1, wherein said lower coil has a spiral shape.

4. The thin-film inductor according to claim 1, wherein said electrically conductive structure further includes an upper insulating layer disposed over said upper coil, and a lower insulating layer disposed over said lower coil.

5. The thin-film inductor according to claim 1, wherein said inductance-enhancing structure is made of a magnetic material.

6. The thin-film inductor according to claim 1, wherein said terminal electrodes include a first layer made of copper and formed on said electrode contact region of said lower coil, a second layer made of nickel and formed on said first layer, and a third layer made of tin and formed on said second layer.

7. The thin-film inductor according to claim 1, further comprising an insulating wrap enclosing said electrically conductive structure and said inductance-enhancing structure such that an electrode surface of each of said terminal electrodes opposite to said lower coil is exposed.
